(19) United States
(12) Patent Application Publication
(10) Pub. No.: US 2017/0370507 A1
(43) Pub. Date: Dec. 28, 2017

(54) Plumbing Connections

(71) Applicant: McAlpine & Co. Ltd., Glasgow (GB)

(72) Inventor: James Edward McAlpine, Paisley (GB)

(21) Appl. No.: 15/631,596

(22) Filed: Jun. 23, 2017

(30) Foreign Application Priority Data
Jun. 24, 2016 (GB) 1611044.7

(51) Int. Cl. F16L 25/14; B29C 65/00

(52) U.S. Cl. CPC F16L 25/14; B29C 66/522

(57) ABSTRACT

A plumbing fitting of a first plastic material comprises at least one annular branch defining a hollow port. A sleeve of a second plastic material can be inserted into the hollow port. The sleeve is retained within the hollow port by a retaining member which is fitted to the outer end and outer wall of the annular branch. The sleeve is configured to facilitate attachment of the plumbing fitting to a second plumbing fitting by insertion of the second plumbing fitting into the hollow port, wherein the second plumbing fitting is of the second plastic material.

### FIELD OF INVENTION

This invention relates to a joining dissimilar materials. In particular, the present invention relates to improvements in joining non-compression joints in plumbing fixtures, for example by gluing.

### BACKGROUND

Typically, plumbing fixtures and pipework are made of similar materials, for example a drain shoe/trap are made from polymers or plastics, for example Acrylonitrile butadiene styrene (ABS) or Poly vinyl chloride (PVC) etc.

Plastic pipe may be flexible or semi-rigid and may include fittings that are either clamped, screwed or glued. Two plastic components, for example a pipe and a trap may be glued together, with the pipe generally being inserted into a hollow port in the trap. Securing the components together requires glue being applied to at least the inside surface of the hollow port and to the outside surface of the pipe over the contact length. The pipe fitting is generally inserted into the hollow port and then given one quarter turn to ensure that the glue is distributed around the circumference of the pipe fitting over the contact length. This ensures that the pipe and the fitting are cemented together, secure and water tight. The material of both parts are typically compatible for gluing or solvent welding.

### SUMMARY OF THE INVENTION

In accordance with a first aspect of the present invention there is provided a plumbing fitting of a first plastic material comprising:

at least one annular branch defining a hollow port;

a sleeve insertable into the hollow port, wherein the sleeve is of a bondable plastic material and comprises a sleeve bore; and

a retaining member receivable on an outer end and outer wall of the annular branch such that the sleeve is retained within the hollow port;

wherein the sleeve is configured to facilitate attachment of the plumbing fitting to a second plumbing fitting by insertion of the second plumbing fitting into the sleeve bore, wherein the second plumbing fitting is of the bondable plastic material.

The purpose of the plumbing fitting defined as the first aspect of the present invention is such that non-compatible materials, for example non-bondable plastic materials and bondable plastic materials can be joined together by bonding methods, for example solvent welding. This can be achieved by a plumbing fitting defined above where the main body of the plumbing fitting is made from a first plastic material which is a substantially non-bondable material, for example polypropylene, but includes an outlet port that is effectively made of a second bondable, material, for example ABS.

The outlet or opening is the part of the plumbing fitting that will be utilised to bond plumbing units together, for example joining the first plumbing fitting to pipework. The hollow port defines an outlet or opening into which is received a hollow insert/sleeve of a second bondable material. As such the insert enables a bonded connection to be made between two dissimilar, normally non-compatible/non-bondable materials.

It will be appreciated that the characteristics of a plumbing fitting according to the present invention can be tailored to suit the environment in which it is being deployed such that non-bondable materials can be used as the main body of the fitting and bondable materials can be included in openings used for joining/linking components.

The first material may be a substantially non bondable plastic material. The annular branch may define an outlet socket.

The retaining member may be a fixed mechanical retaining member receivable on an outer end and outer wall of the annular branch such that the sleeve is permanently fixed within the socket.

The sleeve is configured to facilitate attachment of pipework or a second plumbing fitting, by insertion of the pipework or fitting within the sleeve bore, wherein the pipework or fitting is of the second bondable plastic material.

The plumbing fitting may further comprise a sealing member between an outside wall of the sleeve and an inside wall of the hollow port. The sealing member may be attachable to a first end of the sleeve and insertable into the hollow port with the sleeve, such that leakage between an outside wall of the sleeve and an internal wall of the hollow port is prevented when the sleeve is inserted into the hollow port. The sealing member may comprise an O-ring seal. Alternatively, or in addition, the sealing member may comprise a gasket seal. The sealing member may be rubber.

The sleeve may comprise a reduced diameter section at a first end, wherein the first end is insertable into the hollow port, wherein the reduced diameter section is configured to provide an abutment for the sealing member.

An inner end of the hollow port may comprise a recess configured to receive and engage the sealing member. The recess may include a chamfered surface.

The reduced diameter section may be tapered and/or the recess may be chamfered to ensure a watertight seal by compression of the seal against the tapered surface when the sleeve is inserted in the hollow port.

The sleeve may comprise a tapered outer surface providing an interference fit with the hollow port upon insertion.

The sleeve may include, multiple retaining slots on an end.

The sleeve may be made of bondable, plastic, for example ABS or PVC.

A second end of the sleeve may comprise a flange, which abuts against an outer end of the annular branch when the sleeve is inserted in the hollow port.

The retaining member may comprise a collar engageable with an outer diameter of the annular branch of the first plumbing fitting. The collar may comprise an internal threaded section, operable to engage with a corresponding outer threaded section on the annular branch of the first plumbing fitting. Alternatively, the collar may comprise a wall structure operable to snap fit to the end of the annular branch of the first plumbing fitting. Alternatively, the collar may be formed as a moulding, which is moulded onto at least a portion of the outer wall of the annular branch of the first plumbing fitting and provides an end portion to retain the sleeve within the hollow port defined by the annular branch of the first plumbing fitting.

The retaining element may be made of the first plastic material.

A further aspect of the present invention provides method of joining a first plumbing fitting of a first plastic material to a second plumbing fitting of a bondable plastic material, the method comprising the steps of:
taking a first plumbing fitting of a first plastic material;
inserting an adapter comprising a sleeve of a bondable plastic material into a hollow port defined by an annular branch of the first plumbing element;
attaching a retaining member to an end of the annular branch such that the adapter is retained within the hollow port;
taking a second plumbing fitting of bondable plastic material;
applying an adhesive component compatible with the bondable plastic material to at least an inside surface of the adapter and/or an outside surface of the second plumbing fitting; and

inserting the second plumbing fitting into the adapter.

The method may further comprise rotating the second plumbing fitting as it is inserted into the adapter. By rotating the second plumbing fitting a continuous adhesive layer may be ensured.

The step of attaching a retaining member to the end of the annular branch may comprise moulding a component of the first plastic material over the annular branch of the first plumbing fitting.

Alternatively, the step of attaching a retaining member may comprise screwing the retaining member to the annular member of the first plumbing fitting.

Alternatively, the step of attaching a retaining member may comprise a snap fit.

The step of inserting the adapter into the hollow port may further comprise inserting a sealing member into the hollow port before inserting the sleeve. Alternatively, the step of inserting the adapter into the hollow port may further comprise attaching a sealing member to the end of the sleeve being inserted into the hollow port before inserting the adapter into the hollow port.

A further aspect of the present invention provides an adapter operable to facilitate joining a first plumbing fitting of a first plastic material to a second plumbing fitting of a bondable plastic material, wherein the first plumbing fitting comprises an annular branch defining a hollow port configured to receive the adapter and the second plumbing fitting, wherein the adapter comprises: a sleeve of a bondable plastic material compatible with the bondable plastic material of the second plumbing fitting, wherein the sleeve is insertable into the hollow port; and a retaining member receivable on an outer wall of the hollow port such that the sleeve is retained within the hollow port.

The adapter may further comprise a sealing member attachable to a first end of the sleeve and insertable into the hollow port, such that leakage between an outside wall of the sleeve and an internal wall of the hollow port is prevented when the sleeve is inserted into the hollow port.

The sleeve may comprise an internal thread along at least part of its length.

The sleeve may comprise a tapered outer surface providing an interference fit with the hollow port upon insertion.

The sleeve may comprise a reduced diameter section at a first end, wherein the first end is insertable into the hollow port, wherein the reduced diameter section is configured to provide an abutment for the sealing member. The reduced diameter section may be tapered to ensure a watertight seal when the sleeve is inserted in the hollow port by compression of the seal against the tapered surface.

The sealing member may comprise an O-ring seal. Alternatively, or in addition, the sealing member may comprise a gasket seal.

The first end of the sleeve and an inner end of the annular branch are each configured such that the O-ring compresses against an end surface of the annular branch and the face of the sleeve.

A second end of the sleeve may comprise a flange, which abuts against an outer end of the annular branch when the sleeve is inserted in the hollow port.

The retaining member may comprise a collar engageable with an outer diameter of the annular branch of the first plumbing fitting.

The retaining member may comprise an internal threaded section, operable to engage with a corresponding outer threaded section on the annular branch of the first plumbing fitting. Alternatively, the retaining member may comprise a wall structure operable to snap fit to the end of the annular branch of the first plumbing fitting. Alternatively, the retaining member may be moulded onto at least a portion of the outer wall of the annular branch of the first plumbing fitting and to provide an end portion to retain the sleeve within the hollow port defined by the annular branch of the first plumbing fitting.

The retaining element may be made of the first plastic material.

By providing a sleeve of the same material as the second plumbing fitting means that the first plumbing fitting can be made of a different material than the second plumbing fitting, and therefore the type of material used for the first plumbing fitting can be tailored to the application in which the fitting is to be used. For example, a first plumbing fitting may be a drain shoe or trap and the second plumbing fitting may be pipework. It will be appreciated that a preference for pipe work would be flexibility and cost. Therefore, the pipework is generally made of ABS or PVC.

In the event that the drain shoe or trap are made from ABS or PVC it is found that the material can be attacked by acid, can become brittle over time in use, can become overstressed in use, which may result in cracks developing, which leads to leakage and failure.

A versatile material for manufacture of drain shoes, traps and the like has been found to be polypropylene. However, when using polypropylene for the drain-shoe or trap and using ABS or PVC for the pipe work presents a problem when the two plumbing fitting (drain-shoe and pipework) are to be joined together by gluing, cementing or solvent welding because Polypropylene, ABS and PVC each have different material properties and characteristics, in particular shrink rates, which means that a secure attachment is not always guaranteed. Accordingly, a plumbing fitting, an adapter and a method according to the aspects of the present invention allow a more versatile or robust material to be used for the drain-shoe or trap or the like, without comprising on the security of the glued or cemented joint between two plumbing components. As such the adapter facilitates secure attachment of two plumbing components made of two different materials, where the joining of the two different materials is typically problematic.

### BRIEF DESCRIPTION OF THE DRAWINGS

Embodiments of the invention are further described hereinafter with reference to the accompanying drawings, in which:

FIG. 1 is a schematic representation of an exploded assembly of a drain shoe comprising an adapter in accordance with an embodiment of the present invention;

FIG. 2 is a schematic representation of an assembly of the drain shoe of FIG. 1;

FIG. 3 is a schematic representation of a seal arrangement as used with the adapter as illustrated in FIGS. 1 and 2; and

FIG. 4 is an enlarged view of a portion of FIG. 3.

### DESCRIPTION OF AN EMBODIMENT

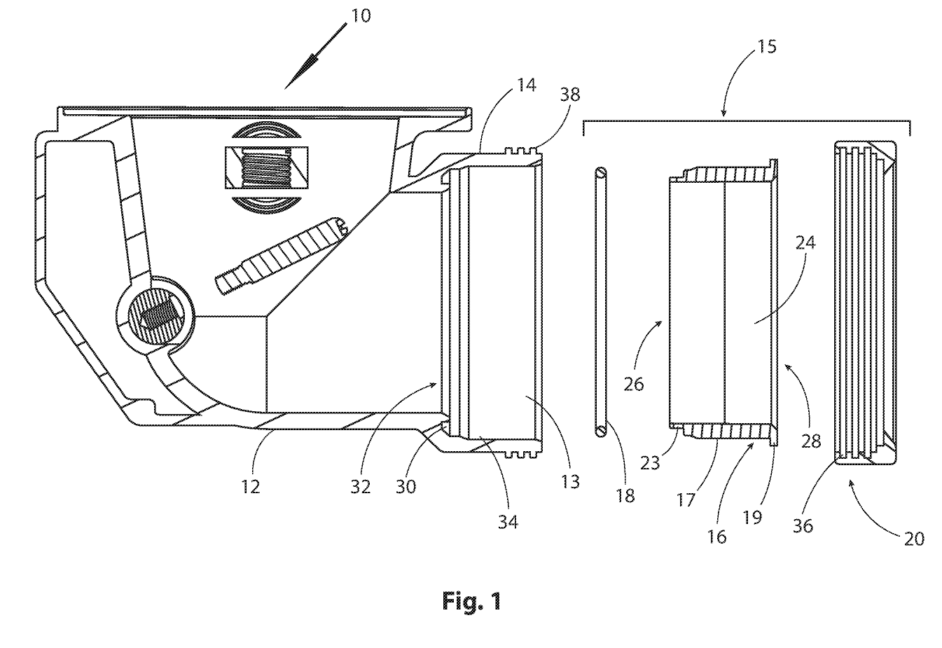

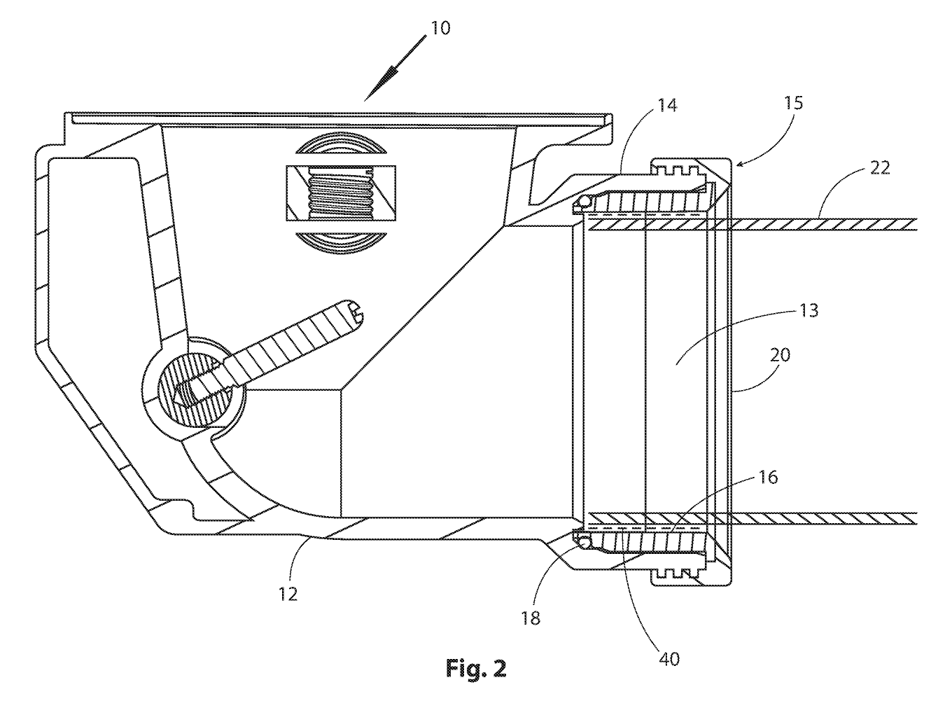

FIG. 1 and FIG. 2 illustrate a drain-shoe 10 as an example of a first plumbing fitting, which is to be attached to a second plumbing fitting, for example pipework 22 (see FIG. 2).

In the illustrated example, the drain-shoe 10 is moulded from polypropylene and the pipework 22 is made of ABS or PVC. The pipework 22 (see FIG. 2) facilitates removal of waste water from the sanitary ware component to waste, for example a sewer.

The drain shoe 10 is configured to be attached to the underside of a sanitary ware component such as a bath, shower, sink or the like (not illustrated) and is designed to remove waste water from the sanitary ware component. Accordingly, the drain-shoe 10 includes a hollow body 12, from which extends a branch 14 which defines a hollow outlet port 13.

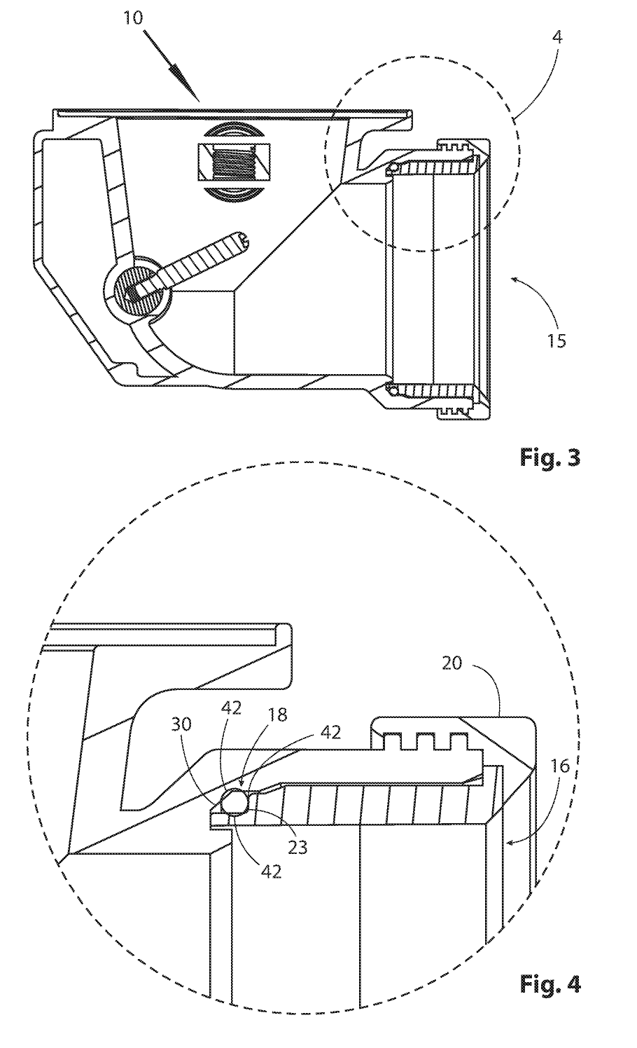

FIG. 1 illustrates an exploded view of the drain shoe 10 such that the components of an adapter 15 according to an embodiment of the present invention can be viewed more clearly. FIGS. 2 and 3 show the assembled drain shoe 10, which comprises the adapter 15 secured inside the outlet port 13.

The adapter includes a hollow sleeve 16, which is inserted into the outlet port and a collar 20, which is connected to the outer end of the branch 14 to secure the sleeve 16 inside the outlet port 13.

In the illustrated example the sleeve 16 includes a through bore 24 which facilitates removal of waste from the drain shoe 10 when the sleeve 16 is inserted in the outlet port 13 as discussed further below.

The sleeve 16 may include a slight taper along the outer wall 17 to ensure a tight fit within the outlet 13. A step 23 is provided at the inner end 26 and a flange 19 is provided at the outer end 28.

An O-ring seal is located on step 23 before the sleeve 16 is inserted into the outlet 13.

The outlet port 13 includes a chamfered recess 30 at the inner end 32 of the port 13. The recess 30 is configured to receive the O-ring seal 18 and to interact with the step 23 such that the O-ring seal 18 is compressed into sealing engagement with the inner surface of the drain shoe 10 and the surface of the step 23 such that when the sleeve 16 and O-ring 18 are inserted, the connection between the outlet port 13 and the sleeve 18 is water tight. Accordingly, leakage of waste water is via the interface of the outside wall 17 of the sleeve 16 and the inside wall 34 of the outlet port 13 is prevented.

FIG. 3, in particular the detail in FIG. 4, illustrates how the O-ring 18 interacts with the surfaces of the chamfered recess 30 and the step 23 to create a barrier to leakage. The points of contact 42 between the O-ring 18, the chamfered recess 30 and the step 23 are evident from FIG. 4; these points represent how the O-ring 18 may be compressed to prevent leakage when the sleeve 16 is inserted into the outlet port 13.

In the illustrated example the internal and external surfaces of the sleeve 16 are smooth. However, one or both of the surfaces may incorporate a surface finish or shape, for example threaded or knurled or tapered etc in order to ensure a watertight fit between the sleeve 16 and the outlet 13.

The inner surface 34 of the sleeve may be configured for solvent welding as a means of joining, two pieces of plastic pipes using a glue which is commonly known as solvent weld cement, The illustrated example represents an assembly where the pipe 22 is solvently welded to the inside wall of the sleeve 16.

Alternatively, the sleeve 16 may include an internal thread (not illustrated) for receiving a second plumbing fitting, which includes an external thread. Alternatively, the sleeve 16 may act as a pipe size adapter, where the internal bore of the sleeve 6 is sized appropriately to accommodate a reduced diameter pipe section.

In the illustrated embodiment, upon insertion of the sleeve 16 and the O-ring 18 into port 13 the flange 19 rests against an outer end of the branch 14. A collar 20 is secured against the flange 19 and to the outside wall of the branch 14.

In the illustrated example, the collar 20 includes an internal thread 36 and the outer wall of the branch 14 includes an external thread 38; therefore, by rotation of the collar 20 relative to the branch 14 the collar is secured against the flange 19 to secure the sleeve 16 inside the outlet 13. The flange 19 acts as a stop for the collar 20.

An alternative method of securing the collar 20 to the drain shoe 10 may comprise moulding a collar 20 of similar material or the same material to the drain shoe 10 over the end of the branch 14.

A further example of a method of securing a collar 20 to the end of the branch 14 is a snap fit arrangement (not illustrated).

In the illustrated example the drain shoe 10 is made of polypropylene, the pipe fitting 22 is of ABS or PVC and the sleeve 16 is made of ABS or PVC. The pipe fitting 22 is fitted to the drain shoe 10 by gluing, cementing or solvent welding. This involves liberally applying glue/cement 40 (see FIG. 2) to the inside surface of the sleeve 16 and to the outside surface of the pipe 22, inserting the pipe 22 into the sleeve 16 and allowing the glue/cement to set, which has the effect of welding the parts together.

Due to different material properties and characteristics attempts to solvent weld polypropylene to PVC or ABS is unreliable. Therefore, embodiments of the present invention allow a first plumbing fitting to be made of polypropylene, which is less vulnerable to damage due to acid etc. and to be reliably joined, by cementing or gluing to a second plumbing fitting which is male of a different material.

By using an adapter 15 as described above the versatility is introduced to the manufacture and assembly of plumbing fittings. As such components made of different materials could be combined, whereas previously combining such materials would never have been considered or explored suitable materials can be explored.

While the invention has been shown and described with reference to certain exemplary embodiments thereof, it will be understood by those skilled in the art that various changes in form and details may be made therein without departing from the scope of the invention as defined by the appended claims and their equivalents.

1. A first plumbing fitting of a first plastic material comprising:
at least one annular branch defining a hollow port;
a sleeve insertable into the hollow port, wherein the sleeve is of a bondable plastic material and the sleeve comprises a sleeve bore; and
a retaining member receivable on an outer end and outer wall of the annular branch such that the retaining member is operable to retain the sleeve within the hollow port;
wherein the sleeve is configured to facilitate attachment of the first plumbing fitting to a second plumbing fitting by insertion of the second plumbing fitting into the sleeve bore, wherein the second plumbing fitting is of bondable plastic material.

2. The first plumbing fitting as claimed in claim 1, further comprising a sealing member attachable to a first end of the sleeve and insertable into the hollow port, such that leakage between an outside wall of the sleeve and an internal wall of the hollow port is prevented when the sleeve is inserted into the hollow port.

3. The first plumbing fitting as claimed in claim 2, wherein the sealing member comprises an O-ring seal.

4. The first plumbing fitting as claimed in claim 2, wherein the sealing member comprises a gasket seal.

5. The first plumbing fitting as claimed in claim 2, wherein the sleeve comprises a reduced diameter section at a first end, wherein the first end is insertable into the hollow port, wherein the reduced diameter section is configured to provide an abutment for the sealing member.

6. The first plumbing fitting as claimed in claim 2, wherein an inner end of the hollow port comprises a chamfered recess configured to receive and engage the sealing member.

7. The first plumbing fitting as claimed in claim 5, wherein the reduced diameter section is tapered to ensure a watertight seal when the sleeve is inserted in the hollow port by compression of the seal against the tapered reduced diameter section.

8. The first plumbing fitting as claimed in claim 1, wherein the sleeve comprises a tapered outer surface providing an interference fit with the hollow port upon insertion.

9. The first plumbing fitting as claimed in claim 1, wherein a second end of the sleeve comprises a flange, which abuts against an outer end of the annular branch when the sleeve is inserted in the hollow port.

10. The first plumbing fitting as claimed in claim 1, wherein the retaining member comprises a collar engageable with an outer diameter of the annular branch of the first plumbing fitting.

11. The first plumbing fitting as claimed in claim 10, wherein, the retaining member comprises an internal threaded section, operable to engage with a corresponding outer threaded section on the annular branch of the first plumbing fitting.

12. The first plumbing fitting as claimed in claim 10, wherein the retaining member comprises a wall structure operable to snap fit to the outer end of the annular branch of the first plumbing fitting.

13. The first plumbing fitting as claimed in claim 10, wherein the retaining member is a moulding, which is moulded onto at least a portion of the outer wall of the annular branch of the first plumbing fitting and provides an end portion to retain the sleeve within the hollow port defined by the annular branch of the first plumbing fitting.

14. The first plumbing fitting as claimed in claim 10, wherein the retaining member is made of the first plastic material.

15. A method of joining a first plumbing fitting of a first plastic material to a second plumbing fitting of a second plastic material, the method comprising the steps of:
taking a first plumbing fitting of a first plastic material;
inserting an adapter comprising a sleeve of a second plastic material into a hollow port defined by an annular branch of the first plumbing fitting,
attaching a retaining member to an end of the annular branch such that the adapter is retained within the hollow port;
taking a second plumbing fitting of a second material;
applying an adhesive component compatible with the second plastic material to at least an inside surface of the sleeve and/or an outside surface of the second plumbing fitting; and
inserting the second plumbing fitting into the adapter.

16. A method as claimed in claim 15, further comprises rotating the second plumbing fitting as it is inserted into the adapter.

17. A method as claimed in claim 15, wherein the step of attaching a retaining member to the end of the annular branch comprises moulding a component of the first plastic material over the annular branch of the first plumbing fitting.

18. (canceled)

19. (canceled)

20. A method as claimed in any of claim 15, wherein the step of inserting the adapter into the hollow port further comprises inserting a sealing member into the hollow port before inserting the sleeve.

21. A method as claimed in any of claim 15, wherein the step of inserting the adapter into the hollow port further comprises attaching a sealing member to the end of the sleeve being inserted into the hollow port before inserting the adapter into the hollow port.

22. An adapter operable to facilitate joining a first plumbing fitting of a first plastic material to a second plumbing fitting of a second plastic material, wherein the first plumbing fitting comprises an annular branch defining a hollow port configured to receive the adapter, which is configured to receive the second plumbing fitting, wherein the adapter comprises:
a sleeve of a plastic material compatible with the second plastic material, wherein the sleeve is insertable into the hollow port; and
a retaining member receivable on an outer wall of annular branch defining the hollow port such that the sleeve is retained within the hollow port.

23-37. (canceled)
